(19) United States
(12) Patent Application Publication
(10) Pub. No.: US 2025/0348717 A1
(43) Pub. Date: Nov. 13, 2025

(54) SYSTEM AND METHOD OF NEURAL NETWORK PROCESSING USING STRUCTURED SPARSE DATA WITH STRUCTURED SPARSE INSTRUCTIONS

(71) Applicant: Neuralmagic Inc., Somerville, MA (US)

(72) Inventors: Alexander MATVEEV, Cambridge, MA (US); Nir SHAVIT, Cambridge, MA (US)

(73) Assignee: Neuralmagic Inc., Somerville, MA (US)

(21) Appl. No.: 19/205,121

(22) Filed: May 12, 2025

Related U.S. Application Data
(60) Provisional application No. 63/646,052, filed on May 13, 2024.

(51) Int. Cl. G06N 3/0495; G06F 17/16

(52) U.S. Cl. CPC G06N 3/0495; G06F 17/16

(57) ABSTRACT

A system and method for processing, executing or training a neural network (NN) may input a first weight matrix storing weights using sparsity defined by a first ratio of non-sparse elements to elements; convert the first weight matrix to a second weight matrix storing weights using sparsity defined by a second ratio of non-sparse elements to elements; and input the second weight matrix into a processor instruction designed to use an input defined by a second ratio of non-sparse elements to elements.

### RELATED APPLICATION DATA

The present application claims benefit from U.S. provisional Patent Application No. 63/646,052, filed on May 13, 2024, incorporated herein by reference in its entirety.

### FIELD OF THE INVENTION

The present invention relates generally to the field of neural networks (NNs). More specifically, the present invention relates to improving the use of structured sparse instructions in processors such as graphics processing units (GPUs), or other processors such as GPUs.

### BACKGROUND OF THE INVENTION

Neural networks (NN) or connectionist systems are computing systems inspired by biological computing systems, but operating using manufactured digital computing technology. NNs are made up of computing units typically called neurons (which are artificial neurons or nodes, as opposed to biological neurons), arranged for example in layers and communicating with each other via connections links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds.

In practice, a NN, or NN learning, can be simulated by one or more computing nodes or cores, such as generic central processing units (CPUs, e.g. as embodied in personal computers) or graphics processing units (GPUs such as provided by Nvidia Corporation). A NN can be modelled as a mathematical object and translated physically to a CPU or GPU as for example matrix operations where entries in the matrix represent neurons, edges or links and matrix functions represent functions of the NN. CPUs typically have few cores (e.g. less than 10, or several tens); while GPUs typically have thousands of cores.

Sparsity is a quality of NNs that have had certain weights or kernel elements (typically those found to have not contributed as much as do other weights to accurate output) removed by being set to zero. Producing sparsity by zeroing or removing elements may be called pruning. Sparsity increases both computation and memory movement efficiency, as fewer non-zero elements need to be moved from memory and fewer calculations may be performed, compared to non-sparse NN data. Sparsity allows for faster inference on smaller neural networks, as the zeros can be skipped during computation, and the zeros do not need to be stored. The computation for a layer with sparse kernel data may be a sparse times non-sparse matrix-matrix multiplication (MMM) (where density may still exist in activation data), or a sparse matrix times dense vector, or a kernel-sparse convolution.

Sparsity may be unstructured, in that the occurrence of non-zero and zero elements is more or less random, or structured. Structured or block-sparse sparsity creates zero elements in some regular pattern, for example within every X consecutive weight entries, Y are made zero and X-Y are non-sparse (but may be a “natural” zero by chance).

Quantization represents the elements of a NN such as matrices or tensors as low-precision values (e.g. integers) instead of high-precision values (e.g. floating point numbers), reducing the amount of space needed to store them and increasing the rate of computation. Quantization may include a compression technique that allows weights and/or activations of a NN to be reduced in size or compressed, for example from a FP32 32 bit floating point representation (e.g. single-precision floating-point format represented using 32 bits) to lower precision of FP16, BF16 (bfloat16, Brain Floating Point, storing a floating point number using 16 bits), INT8 (an integer stored using 8 bits), INT4 (an integer stored using 4 bits) and even single bit representations. By reducing the size or precision of weights and/or activations to, for example, 8-bit integers, one can move more operations through the memory hierarchy and instruction pipelines and thus deliver improved performance. Precision in the context of NNs may be a measure of the detail in which a numerical data item is expressed, may be measured in bits or by reference to a storage format (e.g. INT8), and is related to the concept of mathematical precision.

Specialized hardware instructions or operations have been devised to speed up machine learning (ML) applications; such instructions may take advantage of or require some form of sparsity. For example, some processor instructions may accept groups of operands in blocks, requiring that a certain number of the operands are zero (sparse) and a certain number are non-sparse, e.g. typically non-zero. The structure of the sparsity across the data may be that for each consecutive group of operands (an instruction accepting one or more groups), X are zero and Y are non-zero. Some GPUs have a structured sparse execution mode, which may be called 2:4 sparsity, where 2 out of 4 consecutive entries are always zero, which allows a 50% sparse weight matrix to be multiplied by a (typically) non-sparse activation matrix or vector. Some AMD processors (from Instinct MI300A and onwards) have data types including FP16 (16 bit floating point representation of values), BF16 (brain float 16 bit representation), TF32 (32 bit tensorfloat representation), FP8 (8 bit floating format), and INT8 (8 bit integer representation) with 2:4 preexisting or native hardware sparsity support.

In 2:4 and 4:8 sparsity instruction sets, the NN weight input is 50% sparse, and is typically structured and block sparsity, such that the non-zero (e.g. non-sparse) values are required to occur in certain positions and groups. In principal, this may produce a 2× speedup in computation and data movement.

In a large language model (LLM) prefill phase, where batches are large and there is a high compute to memory ratio via matrix-matrix multiplies, it may make sense to use the 2:4, or 50%, sparsity construct (or, for example, a Nvidia processor 4:8 sparsity construct) that reduces the overall compute needed to execute a matrix multiply. In a decoding LLM phase, when there is a low compute to memory ratio because of small batch sizes and vector-matrix operations, reducing the total number of weights may be more important.

“N:M” sparsity (e.g., 2:4 and 4:8 sparsity) is becoming increasingly popular for its potential to deliver high model accuracy and computational efficiency for deep learning. However, there is a lack of dedicated GPU kernel implementations for general N:M sparsity with higher sparsity levels beyond 50% (50% of weight values set to zero). A library of efficient GPU kernels for two fundamental operations in neural networks with N:M sparse weights exists, but this is based on exploiting the intrinsic balance characteristic of N:M sparsity, rearranging irregular computation and scattered memory accesses. This library does not use the built-in capabilities of existing GPU 2:4 and 4:8 hardware and their efficient associated representations to speed up N:M structured sparse computation.

Generative LLMs, used for example in chat and image generation, are a powerful new trend in machine learning. There will be a need to inference them at a massive scale, both in the cloud and at the edge, and GPUs are well suited for their execution, for example in cloud implementations. LLMs are a class of models that have a large footprint and large compute requirements. A typical LLM requires a full GPU system to inference, e.g., 6-8 GPUs, to fit a large model. This greatly increases capital expenditure (capex) in the edge (e.g. in a server operated by a user, as opposed to a cloud system) and also makes availability in the cloud much harder.

In LLMs, the inference time and throughput on a typical GPU are dominated by the time to perform the prefill and decoding steps of LLM execution. FIG. 1 depicts example processing in a generative LLM, which may include two main stages. In a prefill stage, prompt tokens have numerical values calculated that the model can understand and work with. In the decoding phase, the model responds to the user prompt by generating a series of vector embeddings representing the deep learning algorithm's response to the input prompt. In decoding the LLM iteratively and sequentially predicts the next token. Prefill is typically compute bound in that the speed is limited by how fast computation can take place; decoding is typically memory bound, since the repetitive memory accesses are more likely to limit speed than is computation.

### SUMMARY OF THE INVENTION

A system and method for processing, executing or training a neural network (NN) may input a first weight matrix, or block of data, storing weights or kernel data using sparsity defined by a first ratio of the non-sparse first weight matrix elements to the first weight matrix elements; convert the first weight matrix to a second weight matrix, or block of data, storing weights using sparsity defined by a second ratio of the second weight matrix non-sparse elements to the second weight matrix elements; and input the second weight matrix into a processor instruction designed to use an input defined by a second ratio of non-sparse elements to elements. Some of “non-sparse” elements contributing to the second ratio may be dummy, pad or zero elements.

A typical embodiment multiplies a typically not sparsified activation matrix A by a sparse weight or kernel matrix B to produce a destination or output matrix or tensor C. However, in other embodiments, activation matrices may be sparsified, and other matrices and matrix operations may be used.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 depicts example processing in a generative LLM, which may include two main stages.

FIG. 2 is a graph of a portion of a NN which may be operated on or computed according to an embodiment of the present invention.

FIG. 3 depicts data used in a structured sparse execution instruction, such as a NVIDIA mma.sp instruction.

FIG. 4 depicts a 4:8 four-bit operand (e.g. FP4) structured sparse execution mechanism used with embodiments of the present invention.

FIG. 5 shows a high-level block diagram of an exemplary computing device which may be an example target architecture used with embodiments of the present invention.

FIG. 6 is a flowchart depicting a method according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

One skilled in the art will realize the invention may be embodied in specific forms other than the examples presented herein without departing from the spirit or essential characteristics thereof. The foregoing embodiments are therefore to be considered in all respects illustrative rather than limiting of the invention described herein. Scope of the invention is thus indicated by the appended claims, rather than by the foregoing description.

In the following detailed description, specific details are set forth in order to provide a thorough understanding of the invention. However, it will be understood that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

In one embodiment, a preexisting or native processor instruction designed to perform NN processing by using an input defined by a certain ratio of non-sparse elements to overall or total data elements in the input or matrix (e.g. 2:4 or 4:8) may be used with a data structure having in fact a lower, different ratio of non-sparse elements to elements (which may correspond to a higher sparsity ratio: e.g. a 2:4 native instruction uses a 50% sparsity ratio, and a 1:4 format may use a 75% sparsity ratio). A 2:4 ratio of non-sparse elements to elements may mean that for every four elements total (sparse or non-sparse), two of the elements are non-sparse, and thus used, the remainder of the elements being zeroed or sparsified, and thus not used. Thus data such as weight or kernel data (e.g. a weight matrix) storing data using sparsity (which may be structured, but need not be) defined by a first ratio of non-sparse elements to total elements in the matrix or block of data may be input and converted to a format (e.g. another weight matrix) storing weights using sparsity (which may be structured, but need not be) defined by a second, typically lower, ratio of non-sparse elements to elements (having a higher sparsity ratio), which may be used as input to a processor instruction designed to use an input defined by the second ratio.

Embodiments may improve speed in NN computation by reducing the amount of data moved from memory, which may in some NN processing, be the primary speed bottleneck, more of a bottleneck than processing speed. Thus, in some embodiments, the fact that the native structured sparsity processor instruction operates on “dummy” values added during conversion (the elements that the instruction considers non-sparse for the purposes of the instruction, and for the measure of the non-sparse/sparse ratio, but which are in fact sparse and zeroed) does not affect processing speed as much as the reduction of movement of data from memory does. However, other benefits may occur, such as processing speed improvements, the ability to store a NN in cache as opposed to memory, etc. Generative LLM models may benefit, as in such models the dominant performance factor may be repetitive movement of (e.g., billions of) weights or parameters from memory, since such models repeat processing, token by token, each time repeating processing of the model and each time possibly requiring movement of all weights from memory to generate each token. Embodiments of the present invention may reduce such movements, and may increase the use of cache for such weights or parameters. Generative models are typically large, and are less likely to fit in or make use of cache as with other models.

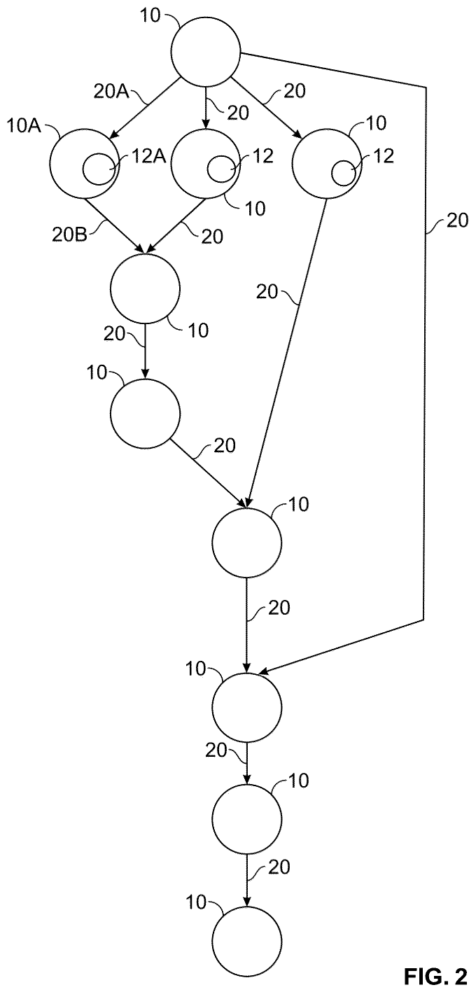

FIG. 2 is a graph of a portion of a NN which may be operated on or computed according to an embodiment of the present invention. FIG. 2 represents a layer of a large language model such as a LLaMA or GPT model, which includes a number of layers or sub-layers. Each layer (or sub layer) 10 may include thousands of neurons, and each edge 20 describes a connection between layers 10, along with the data in that connection (e.g. a tensor). A layer 10 may include a weight or kernel tensor 12 (only a few such tensors are shown for clarity). A matrix multiply (e.g. GEMM) operation in layer 10A may be performed by multiplying weight tensor 12A by an activation tensor provided as part of edge 20A, to produce output (e.g. activation) as part of edge 20B. In a typical embodiment the operations of neurons are performed by target architecture processors such as CPUs, GPUS, etc., but other processors or dedicated circuitry may be used as well.

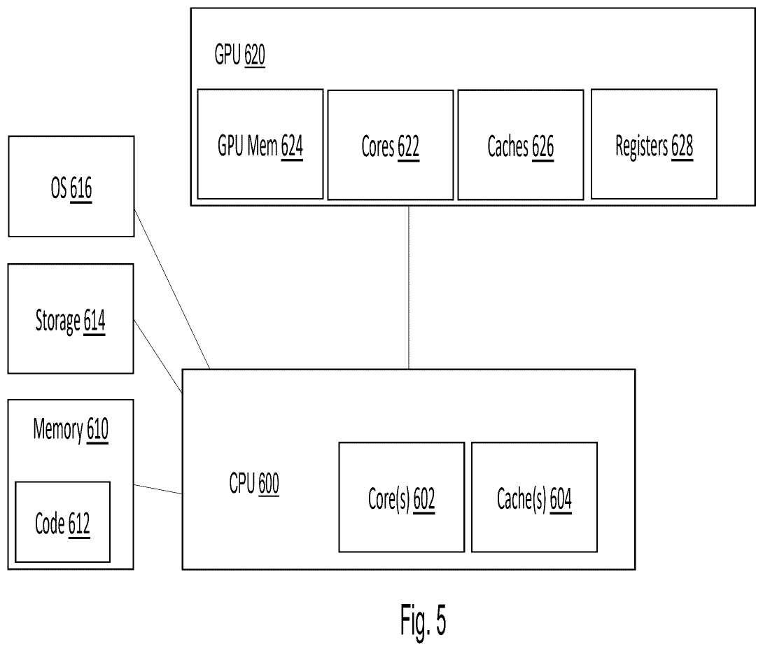

While the portion of the NN shown in FIG. 2 is a portion of an LLM, embodiments of the invention may work with other NNs, for example a convolutional NN (CNN), recurrent neural network, long short-term memory NN (LSTM), U-net, or another other type of neural network. A target architecture such as a processor (e.g. as in FIG. 5) executing a NN may be, e.g. a central processing unit (CPU) such as a general purpose processor, a graphics processing unit (GPU), dedicated hardware or circuitry, or another type of processing unit.

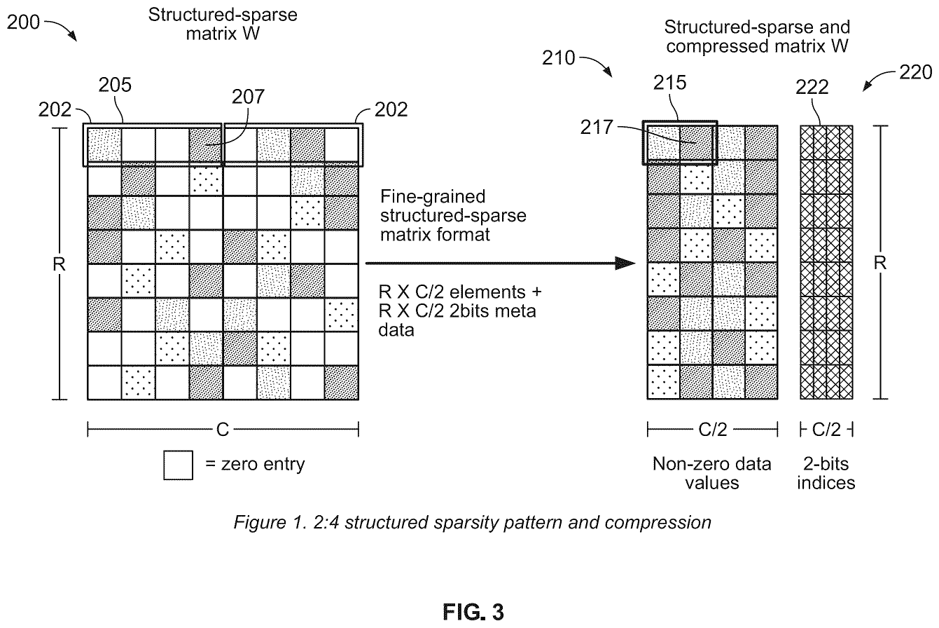

FIG. 3 depicts example data used in a structured sparse execution instruction, such as a NVIDIA mma.sp instruction. Referring to FIG. 3, original dense data matrix 200, storing for example weight data (e.g. a matrix B in a C=A×B calculation, or D=A×B+D calculation), may have structured sparsity, such that in each group 202 of four sequential operands in a row, two are zero and two are non-zero or non-sparse. Elements designated as non-sparse may be in one embodiment those that are used by a processor instruction or NN processing code, and may be zero if by chance such data is zero, naturally. This data may be compressed into a sparse weight matrix including a matrix comprising only non-sparse elements (where some non-sparse elements may be zero, if by chance the original weight is zero) and an associated index or metadata matrix. In this context, dense may indicate a sparsified matrix including zeroed-out elements, and sparse may indicate this sparsified matrix in compressed form, with zeroed out elements removed and location bits, data or metadata added. This weight matrix may be stored in its compressed form (e.g. only the non-sparse elements stored, along with location metadata) in memory, such as memory of the GPU.

For example, the format of the compressed matrix may include sparse (e.g. no sparsified or zeroed elements) matrix 210, including the elements of matrix 200 which have not been sparsified, and excluding sparsified elements of matrix 200. Thus matrix 210 may include, in the same sequence, and in the same rows, pruned and sparsified data of matrix 200, but lacking the entries converted to zero during pruning. Each element of index matrix 220 may indicate, for each corresponding element (e.g. having the same matrix row and column position) of matrix 210, where in the row of matrix 200 the element of matrix 210 data appears. In one embodiment, each element of matrix 220 includes two bits, forming an integer value in the range of 0-3, indicating for the corresponding matrix 210 value where (e.g. the index) within the four-element block of matrix 200 the corresponding matrix 210 value appears in matrix 200. Each four-element block of matrix 200 may have its values appearing in a two-element block of matrix 210. Element 207, appearing in the index position 3 (based on an index range of 0-3) block 205 of matrix 200, may appear in element 217 of two-element block 215 of matrix 210. The position of element 217 in matrix 200 may be indicated by index element 222, which in this particular example may have two 1 values, indicating the last element, element 3 (in a range 0-3), in block 205. Other formats for location bits or data may be used.

Embodiments of the present invention may use pre-existing structured sparsity instructions, which may be designed for a certain ratio or percentage of sparsity (e.g., a second ratio of non-sparse elements to elements), but increase the sparsity used (e.g. to a first ratio of non-sparse elements to elements), and pad the data input to the instruction with zero entries or values (which may be considered zeros used in place of non-sparse values). Such weights may be stored in a matrix, but may be stored in other forms. During conversion or padding a process may create or provide index or placement bits or entries for the added pad values, to produce a second structure or matrix, using sparsity defined by the second ratio of sparse to total elements.

For example, a process may use the 2:4 structured execution format (or the 4:8 format, or other formats) for a GPU instruction designed for 50% sparsity, and use it to deliver higher levels of sparsity than 50%, for example 75% sparsity using a 1:4 format or ratio of sparse to total elements or 87.5% using a 1:8 format or ratio, or 75-87.5% using 2:8 sparsity. 2:8 sparsity may indicate, in some implementations, that 2 non-sparse elements are grouped or adjacent in each 8-element block. Embodiments may have the additional benefit from the reduced weight representation, without losing the benefit of the reduced computation delivered by the 2:4 sparse execution capability of the GPU. Embodiments may reduce the overall representation of weights through sparsity in multiple quantized and non-quantized weight size representations available in 2:4, such as FP16, FP8, FP4, INT8, and INT4, or other representations. Because the representations of these various structured sparsity formats vary, e.g. including 2:4, 4:8, and possibly other formats, different example combinations with different example algorithms are presented herein.

In prior systems implementing sparsity in a GPU there may be a significant overhead in going from the sparse stored representation to the internal executable representation, if stored representations are compressed using compression techniques not amenable to GPU decompression. This lost efficiency may be the reason for much of the poor performance of higher sparsity operations on GPUs. Embodiments may improve NN processing and help to remedy this problem, for example by compressing the data using index bits to indicate where non-sparse elements should be placed. Sparse kernel implementations of some embodiments may achieve streamlined efficiency in the GPU by piggybacking the highly sparse matrix representation of native structured sparsity instructions to produce, e.g. 75% to 87.5% sparsity, using existing hardware supported lower sparsity of 50% sparse with 2:4 or 4:8 GPU computational representations (or other representations used with preexisting GPU instructions).

An embodiment may use pre-existing instructions defined by a first (e.g. 2:4) sparsity ratio of non-sparse elements to overall elements, to perform NN computations using data originally defined by a different (e.g. 1:4) ratio of non-sparse elements to elements. One example embodiment implements 1:4 structured sparsity using the 2:4 structured sparse execution mechanism available on AMD and Nvidia GPUs, from the AMD MI300 and Nvidia Ampere architecture and onwards (other types of GPUs or processors may be used). A 1:4 ratio of non-sparse elements to elements when used with structured sparsity typically means that of every four consecutive weight locations in a matrix or tensor, taken one after the other, at most one weight is non-zero (note that that one “non-sparse” element may actually be zero, if the original weight is zero).

Some embodiments may combine different representations within the same weight matrix and execute them together. For example, if after sparsifying a matrix, it is found that one section has fewer non-zero elements such that higher compression is possible, this section may be represented and stored as higher compression (e.g. 1:8) compared with other sections (e.g. 1:4). An embodiment may permute the matrix such that rows with like compression ratios are stored together.

As can be seen in FIG. 3 the 2:4 format or ratio of non-sparse elements to elements represents a dense matrix (matrix 200 in FIG. 3) of R×C weights as a sparse matrix of R rows, each having C/2 columns of weights (each at a representation of for example FP16, FP8, or INT8) and another C/2 columns of 2-bits each representing the index or position 0 . . . 3 of the weight among four possible locations within a block in the row associated with those columns. In this context, a sparse matrix may include the sparsified elements (e.g. zeros); in contrast to a dense or compressed format, such as a 1:4 or 2:4 format where only the non-zero elements are stored, along with location metadata bits. Thus, for a given four-weight representation in the matrix in 2:4 format, if each weight has, say, an FP16 representation, then it has 2×16 bits representing the two non-zero weights (out of four weights) and also has an additional four bits, 2 bits per weight, denoting where among the 4 original dense matrix locations each of these 2 sparse weights are located.

A format as in matrix 210 may be accepted by a processor instruction designed to use an input defined by a certain ratio of non-sparse elements to elements, such as the AMD and Nvidia 2:4 ratio structured sparsity instructions, and executed efficiently. The improvement over prior art systems may be both from the efficient execution of the matrix multiplications and the reduction of the weights transferred from memory, based on the original input (e.g., structured sparsity defined by a first ratio of non-sparse elements to total elements) compared to the input to the instructions (e.g., structured sparsity defined by a second ratio of non-sparse elements to total elements). For example, an embodiment may take a 4×16=64 bits in the dense (e.g., including zeroed elements) representation and store it in 32+4=36 bits in the sparse one. If the dense representation is INT8 or FP8, then 4×8=32 bits in the dense is replaced by 2×8+4=20 bits in the sparse representation.

Embodiments of the present invention may take this one step further by reducing the number of non-zeros among the adjusted groups of weights (e.g. groups of four weights) in the dense matrix. This may change the ratio defining the sparsity, for example from 2:4 to 1:4, decreasing the ratio and increasing the sparsity. This may result in, in the case of a 1:4 ratio, 75% structured sparsity. The additional location or metadata bits may be reduced: e.g. a 2:4 native format may require 4 location bits, and a 1:4 format according to some embodiments may require only 2 bits when stored. Thus, a single non-zero FP16 weight among four weights may be represented by 16+2=18 bits instead of 64 in a dense format (including three zeroed values), so approximately half the bits as used in the 2:4 representation are used in a 1:4 representation. Similarly INT8 or FP8 may be represented by 8+2=10 bits, also essentially half the bits of a 2:4 representation.

One embodiment utilizes the efficient 2:4 execution on GPU instructions designed to use an input defined by a certain ratio of non-sparse elements to elements. An embodiment may represent and execute the matrix multiplication as per the following example: using FP16 or FP8 preexisting or native 2:4 ratio data to execute in native FP16 (or FP8) hardware, the weights may be compressed or converted as described elsewhere herein, where each R×C weights of a dense matrix (a pruned sparse matrix which retains its original dimensions) turn into or are stored as R rows, each having C/4 columns of weights, and another C/4 columns of 2-bits each representing the index 0 . . . 3 of the weight among 4 possible locations in the row associated with those columns. Other location bit formats may be used. This matrix may be brought into a GPU (e.g. into a swarm) and expanded or converted to a 2:4 format matrix used by a processor instruction. This conversion may take a column on the represented matrix holding a non-sparsified element, and the column's associated index (e.g. two bits), expanding the weight or adding a weight by adding a zero (e.g. FP16 or FP8, or another format) weight (the zero being considered a non-sparse operand by the structured sparsity processor instruction) in the second position of the 2:4 representation (added zero or pad weights may be placed in other positions, such as the first position). A process may place two non-zero location bits corresponding to the non-sparsified element in the lower locations of 4-bits location indices of the 2:4 representation with the higher 2 locations being zero, or having a location corresponding to the added pad bit, or not corresponding to the non-sparsified value. An FP8 execution may require an additional scale multiplication where the scale is provided in a standard format. Other location indication schemes may be used, such as each bit indicating if a corresponding dense matrix location is included in the sparse or compressed representation.

The conversion of the first matrix, storing weights using structured sparsity defined by a first ratio of non-sparse elements to elements, may be by adding zero or pad entries to it (representing non-sparse elements per the relevant instruction format) and creating index entries for these zero entries. Typically, the index or position bits for the dummy values, which are zeroed according to an embodiment but which the native instruction considers to be non-zero, can be arbitrary as long as they do not indicate a position the same as the actual non-zero value. Other ways to indicate position may be used. For example, in the case of four positions, each position entry may be four bits, a one indicating the position of the associated value.

In one embodiment, the weights or kernels of the model are stored in memory, such as CPU and/or GPU memory, with only non-sparse elements (e.g. in 1:4 ratio of non-sparse elements to elements used as examples herein), and also depending on a cache policy and other factors, may also be stored in cache (e.g. a CPU or GPU cache) in this lower size format. When the weights or kernels are moved to the GPU registers, before processing, a process may convert from the higher sparsity format (e.g. 1:4) to the lower sparsity format required by the processor instruction designed to use an input defined by a higher ratio (e.g. 2:4) of non-sparse elements to elements. Thus in some embodiments, converting the first weight matrix to a second weight matrix (each storing weights using sparsity defined by different ratio of non-sparse elements to elements) may occur before moving the data from cache or memory to registers, and may be done piecemeal: the entire matrix need not be converted at once, rather sets of weights or operands may be converted as used by the GPU instruction. Such conversion may be done on-the-fly, at execution time. Such conversion may be performed by the GPU itself. In other embodiments, conversion need not be performed when saving to registers.

At this point the matrix multiplication (or a portion thereof) can be executed by the processor instruction using the efficient structured sparsity defined by a second ratio (e.g. 2:4 mode of the GPU) resulting in output.

Vector operations may be used to execute such an expansion or conversion. For example (without loss of generality), for executing the FP16 m16n8k32 mma.sp NVIDIA PTX (parallel thread execution) instruction, each GPU thread (data-parallel processing maps data elements to parallel processing threads) needs to have 8 FP16 “non-zero” or non-sparsified values inside four 32-bit registers with the associated location or metadata index format. In this case, there may be four non-zero values per thread, since each block is in the structured sparsity ratio of 1:4 (and not 2:4), so it will load each 32-bit register with one 16-bit non-zero (out of the four available) and the other 16-bits will be initialized to 0s. The same will be done for the index metadata: the associated two bits for each non-zero (for a total of 8 bits) will be set based on the NVIDIA PTX format, while the eight missing or dummy bit positions may hold any arbitrary value not being the same as the a value corresponding to actually used non-zero values. The actual value inside the 32-bit registers may be zero for these missing or padded values, so it will not affect the final result. This placement of non-zero values into 32-bit registers and metadata, or in other words, the conversion and their expansion into registers, can be done by the GPU inside a warp/thread-block in a uniform way, since the placement strategy may be identical for all threads inside warp/thread-block, and also the shifting in memory loads/stores may be identical to all threads. As a result, this may avoid any divergence or inefficiencies due to irregular behavior of different threads inside warp/thread-block or irregular memory accesses. After the 32-bit registers of the mma.sp are populated the mma.sp can be executed as usual. In one example only four non-zero values are used per thread to execute a single mma.sp.

An embodiment may perform INT8 weight execution using a native FP16 instruction with a first ratio of non-sparse elements to elements of 2:4. To execute using INT8 operands in FP16 2:4 mode, the weights may be compressed as described elsewhere herein, where each R×C weights of a dense matrix turn into R rows, each having C/4 columns of 8 bit weights, and an associated C/4 columns of 2-bits each representing the metadata or index 0 . . . 3 of the weight among four possible locations in the row associated with those columns. Additionally, each group of weights may have a scale and a zero point. Since this embodiment uses FP16 2:4 execution, where operations are FP16, then an embodiment may take a column on the represented sparse 1:4 matrix in 8-bits and the column's associated 2 index bits, expand the quantized INT8 weight into an FP16 format using the scale and zero point, then add a zero FP16 weight in the second position of the 2:4 representation and place the non-zero 2 bits in the lower locations of 4-bits location indices of the 2:4 representation with the higher 2 locations being zero. The activations may be FP16, or if they are in a INT8 representation they may be expanded to FP16 prior to execution.

After such loading and conversion, the matrix multiplication can be executed using for example the efficient FP16 2:4 mode of the GPU resulting in the same standard 2:4 output format returning the appropriate result since all weights but the non-zero will add 0 to the total sum. For example, the processor instruction may be used as part of computing activation outputs for a neural network layer.

An embodiment may include vector operations to execute such an expansion or conversion. For example (without loss of generality), for running the FP16 m16n8k32 mma.sp NVIDIA PTX instruction, each GPU thread may include eight FP16 “non-zero” values inside four 32-bit registers with the associated metadata format. There may be four non-zeros (e.g. non-sparsified values) per thread, since each block may have a 1:4 structured sparsity ratio (and not 2:4), so it may load each 32-bit register with one 16-bit non-zero value (out of the four available), possibly after dequantizing the values to convert the value from a lower-bit (e.g. 16) representation to a higher-bit (e.g. 32) representation and applying scale and zero-point if necessary; the other 16-bits in the register may be initialized to 0s. An analogous procedure may be done for the index metadata: the associated two bits for each non-zero value (for a total of eight bits) may be placed based on the NVIDIA PTX format, while the eight missing bit positions may hold any arbitrary value not indicating the same position as actual non-sparse data (since the actual value inside the 32-bit registers is 0s for the missing values, it should not affect the final result). This placement of non-zero values into 32-bit registers and metadata, or in other words, their expansion into registers, can be done inside a warp/thread-block by the GPU in a uniform way, since the placement strategy may be in this case identical for all threads inside warp/thread-block, and also the shifting in memory loads/stores may be identical to all threads. As a result, this may avoid any divergence or inefficiencies due to irregular behavior of different threads inside warp/thread-block or irregular memory accesses. In some embodiments, this conversion of data takes place after data is read from GPU memory or cache, and the converted (e.g. expanded) data is placed in GPU registers. In some embodiments, a matrix of data is converted piecemeal, such that only the portion of weight matrix data being used locally in time is converted.

After such conversion, when the 32-bit registers of the mma.sp are populated, the mma.sp can be executed as usual, as part of the calculation of NN values such as the calculation of a layer. In some embodiments only 4 non-zero values are used per thread to execute a single mma.sp. However, an efficient 128-bit vector load on the NVIDIA GPU may load eight non-zero values.

Using native INT8 2:4 sparsity ratio instructions may be similar to the use of native FP16 2:4 with some modifications. Note that one may also represent the weight in a 1:4 sparsity format in any number of bits from eight to one bits (or other formats), with two additional bits for the index, and expand or dequantize it and then execute with this data using the native FP16 or INT8 2:4 execution. For the case of INT4, this may mean 6-bits are used per non-zero or un-sparsified element.

An embodiment may use an instruction requiring a 4:8 structured sparsity ratio for input weight data which is defined and stored according to a 1:8 ratio using four-bit structured sparsity (e.g., where the one non-sparse value is represented by four bits). A specific embodiment may implement 1:8 structured sparsity using the Nvidia 4:8 structured sparse execution mechanism available on Nvidia GPUs from the Ampere architecture and onwards. A 1:8 sparsity ratio means that of every eight consecutive weight locations, taken one after the other in the weight matrix of a neural network, at most one is non-zero.

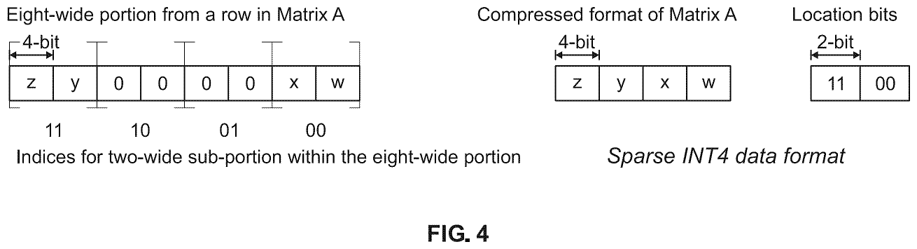

FIG. 4 depicts a 4:8 four-bit non-sparse operand (e.g. FP4) structured sparse execution mechanism used with embodiments of the present invention. An Nvidia 4:8 four-bit or FP4 structured sparse execution mechanism is available on some Nvidia GPUs from the Ampere architecture and onwards. Such a mechanism is similar to the 2:4 ratio mechanism, in that four out of eight 4-bit dense locations are non-zero. However, the 32 bits of the eight four-bit weights may be split into four eight-bit groups (e.g. sub-chunks or sub-portions) and per the instruction data standard the four non-zero weights may occupy at most two of these groups (e.g., they are at two consecutive four-bit weights starting in locations 0 or 8 or 15 or 23). Each chunk of eight adjacent elements in a row has four zero and four non-zero values, where the non-zero values are clustered in sub-portions of two consecutive elements. Thus in some configurations the set of non-sparse elements are consecutive or in a chunk. In the higher sparsity 1:8 weight data stored, according to an embodiment of the invention, in memory the 4-bit non-sparse weight value among eight total values may be represented by 4 (value)+3 (position)=7 bits instead of 32 bits if stored as a 4:8 ratio with two non-sparse values.

An embodiment may perform INT4 format, 1:8 weight ratio, 87.5% sparsity, execution using a native 4:8 INT4 (or FP4, or other format) instruction to execute in an INT4 format instructions on weights that are compressed as described elsewhere herein, where each R×C weights of a dense matrix turn into R rows, each having C/8 columns of 4 bit weights, and another C/8 columns of 3-bits each representing the index 0 . . . 7 of the weight among 8 possible locations in the row associated with those columns. Additionally, each group of weights may have a scale and a zero point.

In an embodiment using a 4:8 sparsity ratio for processor instruction execution, may take as input a column on the represented sparse 1:8 matrix in 4-bits and the column's associated 3 bit index, and expand the quantized INT4 weight into the lower or the higher of the first 8 bits of the 4:8 weight input matrix, with the remaining 4 bits of the 8-bits set to 0. This location may be determined by the index's parity bit (e.g., if it is odd in dense locations 7 or 5 or 3 or 1, then the location is in the higher 4 bits and if it is even, it is in the lower 4-bits). The weight should now be in the correct position in the group. The higher 8-bits of the 4:8 weight representation may be padded or set to 0, e.g. a dummy value. The remaining more significant 2-bits of the index may be used as the lower bits of the 4-bit 4:8 index representation, indicating the location of the group set up with the non-zero value among the 4 possible 8-bit groups in the 32 bit 4:8 representation. A similar algorithm may be used for FP4 values, as with INT4 values. The rest of the computation now proceeds as usual with 4:8 structured sparsity processor instruction execution, returning the appropriate result since all weights but the non-zero will add 0 to the total sum. (Zero points and/or scales may be used and added as appropriate).

For example (without loss of generality), when executing an INT8 m16n8k32 mma.sp NVIDIA PTX instruction, each GPU thread should have eight INT8 “non-zero” or un-sparsified values (which may be zero by chance) inside two 32-bit registers with the associated metadata format. In an embodiment, there may be four non-zeros or un-sparsified values per thread, since each block is defined by a 1:4 ratio of non-sparse elements to elements (and not 2:4), so it may load each 32-bit register with two 8-bit non-zero elements, the first 8-bit non-zero element into bit range [0 . . . 15] and the second 8-bit non-zero element into bit range [16 . . . 31] (out of the four available in this example, after dequantizing the values and applying scale and zero-point if necessary) and the other 16-bits will be initialized to 0s. The same may be done for the metadata: the associated 2 bits for each non-zero value (for a total of 8 bits in this example) will be placed based on the processor instruction format (e.g. the NVIDIA PTX format), while the 8 missing bit positions may hold any arbitrary value (except for the value associated with the actual non-sparse element), since the actual value inside the 32-bit registers is 0 for each of the missing values, so it will not affect the final result. This placement of non-zero values into 32-bit registers and metadata, or in other words, their expansion into registers, can be done inside a warp/thread-block in a uniform way, since the placement strategy may be identical for all threads inside warp/thread-block, and also the shifting in memory loads/stores may be identical to all threads. As a result, it avoids any divergence or inefficiencies due to irregular behavior of different threads inside a warp/thread-block or irregular memory accesses. After the 32-bit registers of the mma.sp are populated the mma.sp can be executed as usual. In one embodiment only eight 8-bit non-zero values are used per thread to run a single mma.sp. However, an efficient 128-bit vector load on the NVIDIA GPU may load 16 non-zero values. To accommodate this, a thread may loop over the eight (e.g., 8-bit) groups of non-zero values to compute multiple mma.sp instructions, based on the amount of data available.

An embodiment may use structured sparsity defined by a 2:4 ratio of non-sparse elements to elements for 2:8 four-bit structured sparsity. An embodiment may implement 2:8 structured INT4 or FP4 sparsity using a 4:8 structured sparse processor execution mechanism available for example on Nvidia GPUs from the Ampere architecture onwards. A 2:8 sparsity ratio means that of every eight consecutive weight locations, taken one after the other in the weight matrix of a neural network, at most two, in any of the eight locations, not necessarily consecutive, is non-zero or non-sparse. (If one wishes to have them be consecutive then the algorithm immediately follows from the 1:4 format discussed elsewhere with few changes except execution using the native 4:8 format instead of the 2:4 mode of the GPU).

The two four-bit weights among eight may be represented by 8+6=14 bits instead of 32. Each value may have 4-bits of weight and 3-bits of location. The location of each weight of the two may be determined by the 3-bits similarly to the 1:8 ratio implementation discussed elsewhere when each of the weights is in a separate group of consecutive two weights, and using the same or similar representation as a 1:4 ratio implementation when the two weights are in the same group of consecutive two.

One skilled in the art would understand how to implement the representations discussed herein to implement lower bit weights (e.g., represented using fewer bits) than 4-bits or 8-bits depending on the smallest word size they fit in, e.g. 4 or 8 or 16.

FIG. 5 shows a high-level block diagram of an exemplary computing device which may be an example target architecture used with embodiments of the present invention. In some embodiments the computing device of FIG. 5 may perform NN processing as described herein.

The computing device of FIG. 5 may be or be part of a NN execution platform, such as a computer within a device (e.g. a car), personal computer, laptop, smartphone, workstation, server, cloud computing system, etc. CPU 600 may include one or more processing cores 602, one or more caches 604, and other components. CPU 600 may have a cache hierarchy with higher, faster and smaller private caches (e.g. L1, L2) each associated with a specific core 602, and lower, larger caches (e.g. L3) shared among cores 602. Different numbers of cores and cache structures may be used. CPU 600 may be connected to a large but slower (typically order of magnitude slower) external memory 610 such as a DRAM memory. Some of the components shown in FIG. 5 may be omitted; other components may be used.

Computing device 600 may be connected to and/or operate in conjunction with operating system (OS) 616, a long term storage 614, and other components such as input devices and output devices. Operating system 616 may be or may include any code segment to coordinate, schedule, arbitrate or control operation of the computing device, for example, scheduling execution of programs. Input devices may be or may include for example a mouse, a keyboard, a touch screen etc. Output devices may include displays, speakers and/or any other suitable output devices.

Memory 610 may be or may include, for example, a Random Access Memory (RAM), a read only memory (ROM), a Dynamic RAM (DRAM), a Flash memory, a volatile or non-volatile memory, or other suitable storage. Memory 610 may include a plurality of, possibly different memory units. Memory 610 may store instructions to carry out a method (e.g. code 612) as described herein, and/or data such as NN data, data describing a NN, NN kernel or weight information, etc.

Executable code 612 may be any executable code, application, program, etc. and may be executed by CPU 600 and/or GPU 620. Executable code 612 may when executed cause NN execution or inference or other functions, according to embodiments described herein.

Long term storage 614 may be or may include, for example, a hard disk drive, a floppy disk drive, a Compact Disk (CD) drive, a universal serial bus (USB) device or other suitable storage. Data such as instructions, code, NN model data, parameters, etc. may be stored in a storage 614 and may be loaded from storage 614 into a memory 610 where it may be processed by GPUs 620 and CPUs 600.

GPU 620 may include many cores 622, e.g. 4,096 cores or other numbers. Typically, many (e.g. a swarm of) GPU cores 622 operate using the same instructions but different data at once, and a swarm may refer to a group of cores 622, such as a group of 32 cores 622. A swarm may share a cache of caches 626, such as an L2 cache, where each core in the swarm has its own private (e.g. L1) cache. Other cache structures, and organizations of cores 622, may be used. GPU 620 may include registers 628, fast on-chip memories that are used to store operands for GPU operations, and its own memory 624, e.g. on-chip or off chip, which is typically slower to access and use than caches 626 and registers 628. Other or different GPU and CPU structures may be used. CPUs often have fewer cores (e.g. less than 10) when compared with GPUs which often have thousands of cores. CPUs often have a broader and more powerful instruction set, and fewer but more powerful cores, than do GPUs, which are typically geared towards large-scale math operations.

Caches 626 and 604 are located typically within or as part of the processor they serve on the same chip. Different caches and cache structures may be included in other embodiments. Although example embodiments are described in terms of L1, L2, and L3 cache levels (e.g. as in Intel architectures), embodiments apply to any other architecture, with different cache designs. L1 cache may be faster and smaller than L2 cache which may be faster and smaller than L3 cache. Memory 610 (e.g. DRAM typically external to the die on which the cores exist), and also possibly GPU memory 624, is typically larger than caches but typically an order of magnitude slower memory, and may be physically further from the cores than are caches. In some embodiments, some or all of cache storage may be off-chip, not on the same chip as processors or cores, but in general, access to cache is faster than access to memory 610 and or memory 624.

Target architectures used with embodiments of the present invention may include for example AMD and Nvidia GPUs, e.g. the AMD MI300 processor, the Nvidia Ampere architecture, the AMD Instinct, EPYC or Zen series of processors, Intel's Xeon, Core, or Pentium processors, ARM (Advanced RISC Machines) Cortex or Neoverse processors, CPUs, GPUs, dedicated circuitry, and other processors.

Embodiments of the invention may include one or more article(s) (e.g. memory 610 or storage 614) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, cause or configure the processor to carry out methods disclosed herein.

For the various modules and functions described herein, one or more GPUs 620 and CPUs 600 may be used. One or more processor(s) such as GPUs 620 and CPUs 600 may be configured to carry out embodiments of the present invention by for example executing software or code.

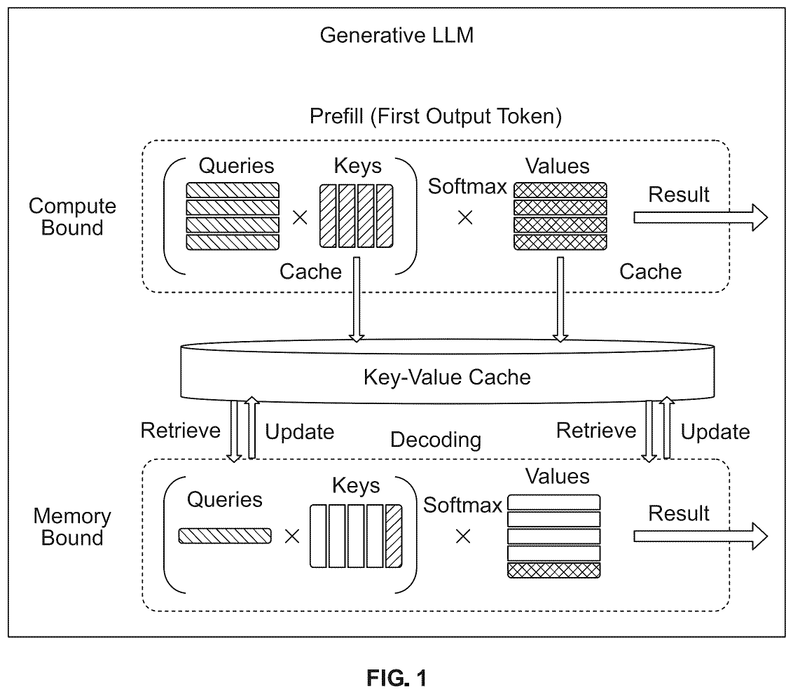

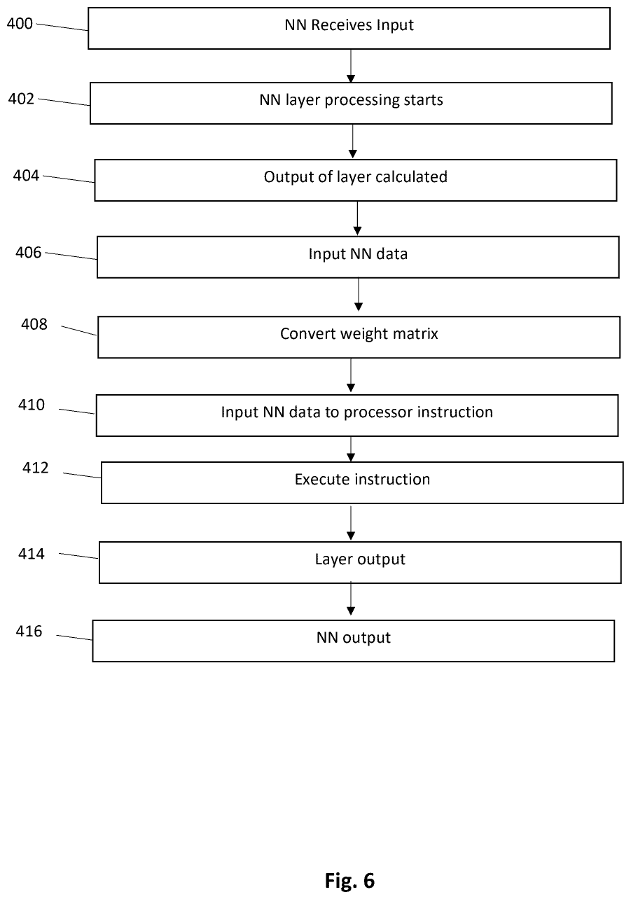

FIG. 6 is a flowchart depicting a method according to embodiments of the present invention. The operations of FIG. 6 may be used with systems such as depicted in FIGS. 1, 2 and 5, but other systems and architectures may be used. The operations of FIG. 6 may be used for performing inference on a NN by accepting an input for the NN and producing an output from the NN, but in some embodiments some of the operations of FIG. 6 may be used for NN training. As with other processes described herein, while an exemplary method is depicted for illustrative purposes in the flowchart of FIG. 6, it will be appreciated by those skilled in the art that features and operations from this procedure may be selectively combined with features and operations from alternative embodiments of the invention without departing from the remit of the disclosure. Further, while certain features and operations are expressly included in the flowchart of FIG. 6 (and other method descriptions herein), it will be appreciated by those skilled in the art that not all depicted features and operations are mandatory elements, and that different embodiments may omit certain features or operations without departing from the remit of the disclosure. Accordingly, embodiments including combinations of the features and operations recited in FIG. 6 are expressly within the remit of the disclosure and do not constitute an intermediate generalization of the same.

In operation 400 input to a NN may be received. Typically, at least a portion of the NN is pruned or sparsified to produce zero elements. In addition, this sparsification may be block or structured sparsification, such that the non-zero elements occur with some structure (e.g. for each X consecutive elements in a weight array, only Y elements is/are non-sparse).

In operation 402 processing may commence for a layer of the NN. While a layer is discussed, processing may be performed based on NN organizational structures other than a layer.

In operation 404, as part of the layer processing, an output may be calculated as a product of weights or kernels and activations; e.g. the output matrix C may be calculated as the product of a weight or kernel matrix A and activation (e.g. the output of a layer) matrix B. In some embodiments, matrix-matrix multiplication may be performed in this manner. Operation 404 may include operations 406-414.

In operation 406, neural network data such as a first weight matrix, kernel data, or a portion or a set of weights or kernel data from the matrix, may be input. The matrix may store weights using sparsity defined by a first ratio of non-sparse elements to overall elements, such as 1:8 indicating one non-sparse element to each of eight elements total. This may be structured sparsity, in that one non-sparse element exists for each consecutive (in the matrix) eight elements overall. This weight matrix when stored in memory may be a dense matrix including only non-sparse elements (and no sparsified elements, which are typically zero, although non-sparse elements may be zero by chance) and index elements indicating the location of associated non-sparse elements. The matrix may be stored in memory, e.g. first in a memory of a CPU which is using a GPU for multiplication, then in the GPU memory (possibly moved into GPU cache per a cache policy): the movement of this data without the “dummy” non-sparse but still zero elements created by padding in operation 408 may improve processing by reducing memory movement and increasing the amount of useful data stored in cache.

In operation 408, the first weight matrix (or a portion of it) may be converted to a second weight matrix storing weights using sparsity defined by a second ratio of non-sparse elements to elements. The second ratio may be higher than the first, indicating lower sparsity. A process may convert from the higher sparsity format (e.g. having fewer non-sparse elements) to the lower sparsity format required by the processor instruction designed to use an input defined by a higher ratio (than that of the stored data) of non-sparse elements to overall elements. This may include adding dummy or pad values, as zero values, to the data, in positions assigned as non-sparse by the processor instruction. This may include creating index or location entries or bits for these zero or pad entries; such index or location entries may also be stored in GPU registers. The index elements may refer to arbitrary locations, since the values they refer to are zero, but should not refer to the non-zero non-sparsified elements stored by the higher sparsity (lower ratio of non-sparse to overall elements) format. This expanded or converted matrix data may be stored in GPU registers, as required by the processor instruction. It is noted that this format, having the additional pad values, if stored in memory, would occupy much more space than the more highly compressed version discussed with respect to operation 404.

This conversion may be performed by the GPU, but may be performed by other processors. Key to performance on a GPU is the uniformity of the access patterns to the represented data and the ease of moving it from a compressed format to one that can be readily executed by the GPU cores/swarms. Embodiments of the invention may take advantage of this by converting or decompressing from higher compression and sparsity to lower compression and sparsity using GPU parallelism. While a high-sparsity in memory or cache and lower sparsity stored in GPU register scheme is described, other storage and data movement schemes may be used.

Whether or not a portion or the entirety of the dense matrix is fetched from memory in operation 404, in some embodiments a portion of the first weight matrix may be converted to the second weight matrix at a time, and in some processor architectures, that portion of the converted second weight matrix may be stored in a register for input to an instruction. In some embodiments a portion of the matrix having a first ratio of non-sparse/elements is fetched from memory connected to a CPU and sent to GPU memory, kept in GPU cache, fetched from GPU cache, converted by the GPU to a set of data having a higher ratio of non-sparse/sparse elements (using dummy non-sparse elements), saved to a GPU register, and then used by a GPU instruction.

In operation 410, the second weight matrix, or a converted chunk of that matrix, may be input into or received by a processor instruction designed to use an input defined by a ratio of non-sparse elements to elements which is typically higher than the ratio used by an embodiment of the invention for storage of that data (e.g. the pre-conversion ratio). The input may be from a GPU register, or another location.

In operation 412, the instruction may execute. Typically in a GPU many of the same type of instruction execute at the same time, and thus many portions of the input matrix may be operated on at once. The instruction may produce output, which may form output activations for a layer or portion of a NN. Multiple GPU instructions may execute at the same time, each using different data. Operation 412 may be performed repeatedly on converted data before further data is converted.

Operations 406-412 may be done repeatedly such that an entire matrix of weights is converted and processed a chunk at a time, not all at once.

In operation 414, the output for the layer to be computed may be output (e.g. as activations), and if further processing of the NN is needed (e.g. more layers are to be computed) this may proceed, which may include moving to operation 402 to start on another layer of the NN. Organizing processing in units other than layers may be performed.

In operation 416, the NN may produce output.

Other operations or series of operations may be performed.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer or other electronic computing device, that manipulates and/or transforms data represented as physical (e.g., electronic) quantities within the computer's registers or memories into other data similarly represented as physical quantities within the computer's registers and/or memories or other non-transitory storage medium that may store instructions to perform operations and/or processes.

The term set when used herein may include zero or more items. Unless explicitly stated, the method embodiments described herein are not constrained to a particular order or sequence. Some of the described method embodiments or elements thereof can occur or be performed simultaneously, at the same point in time, or concurrently.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for neural network processing, the method comprising:
inputting a first weight matrix storing weights using sparsity defined by a first ratio of the non-sparse first weight matrix elements to the first weight matrix elements;
converting the first weight matrix to a second weight matrix storing weights using sparsity defined by a second ratio of the second weight matrix non-sparse elements to the second weight matrix elements; and
inputting the second weight matrix into a processor instruction designed to use an input defined by the second ratio of the non-sparse elements to the elements.

2. The method of claim 1, wherein the converting comprises adding zero entries and creating index entries for the zero entries.

3. The method of claim 1, wherein the first weight matrix comprises a dense matrix comprising only non-sparse elements and an index matrix.

4. The method of claim 1, further comprising computing activation outputs for a neural network layer using the processor instruction.

5. The method of claim 1, wherein the first ratio is lower than the second ratio.

6. The method of claim 1, wherein inputting the first weight matrix comprises inputting a portion of the first weight matrix, and wherein a portion of the second weight matrix is stored in a register.

7. The method of claim 1, wherein the sparsity of the first weight matrix is structured sparsity.

8. A system for neural network processing, the system comprising:
a memory; and
one or more processors to:
input a first weight matrix storing weights using sparsity defined by a first ratio of the non-sparse first weight matrix elements to the first weight matrix elements;
convert the first weight matrix to a second weight matrix storing weights using sparsity defined by a second ratio of the second weight matrix non-sparse elements to the second weight matrix elements; and
input the second weight matrix into a processor instruction designed to use an input defined by the second ratio of the non-sparse elements to the elements.

9. The system of claim 8, wherein the converting comprises adding zero entries and creating index entries for the zero entries.

10. The system of claim 8, wherein the first weight matrix comprises a dense matrix comprising only non-sparse elements and an index matrix.

11. The system of claim 8, wherein the one or more processors are further to compute activation outputs for a neural network layer using the processor instruction.

12. The system of claim 8, wherein the first ratio is lower than the second ratio.

13. The system of claim 8, wherein inputting the first weight matrix comprises inputting a portion of the first weight matrix, and wherein a portion of the second weight matrix is stored in a register.

14. The system of claim 8, wherein the sparsity of the first weight matrix is structured sparsity.

15. A method for neural network processing, the method comprising:
inputting first neural network data using sparsity defined by a first ratio of non-sparse elements to total data elements;
converting the first neural network data to second neural network data stored using sparsity defined by a second, higher, ratio of non-sparse elements to total data elements; and
inputting the second neural network data into a processor instruction which is to use an input defined by the second ratio.

16. The method of claim 15, wherein the converting comprises adding dummy entries and creating location data for the dummy entries.

17. The method of claim 15, wherein the first neural network data comprises dense data comprising only non-sparse elements and location data.

18. The method of claim 15, further comprising computing activation outputs for a neural network layer using the processor instruction.

19. The method of claim 15, wherein the sparsity of the first neural network data is structured sparsity.
